(19) United States
(12) Patent Application Publication
(10) Pub. No.: US 2026/0180207 A1
(43) Pub. Date: Jun. 25, 2026

(54) VIBRATION-RESISTANT CONTACT ARRANGEMENT FOR HV CONNECTIONS

(71) Applicant: TE Connectivity Solutions GmbH, Schaffhausen (CH)

(72) Inventors: Kevin SCHEER, Schaffhausen (CH); Harald ULRICH, Schaffhausen (CH)

(21) Appl. No.: 19/423,889

(22) Filed: Dec. 17, 2025

(30) Foreign Application Priority Data
Dec. 23, 2024 (DE) 102024139679.2

(51) Int. Cl. H01R 4/30

(52) U.S. Cl. CPC H01R 4/302

(57) ABSTRACT

A contact arrangement for electrical HV connections includes a contact socket and a contact bolt that can be inserted into the contact socket along an insertion direction. The contact arrangement includes a spring arrangement comprising a spring which, when the contact bolt is inserted into the contact socket, is arranged and compressed between the contact socket and the contact bolt in a radial direction. The contact arrangement includes a support surface arrangement which has at least one support surface inclined relative to the insertion direction, wherein the compressed spring is supported on the support surface arrangement and an axial spring force pointing in the insertion direction is generated on the support surface arrangement by the compressed spring supported thereon. Such a contact arrangement is particularly wear-resistant.

### CROSS REFERENCE TO RELATED APPLICATIONS

This application claims the benefit of DE Application No. 102024139679.2, filed 23 Dec. 2024, the subject matter of which is herein incorporated by reference in its entirety.

### BACKGROUND OF THE INVENTION

The subject matter herein relates to a contact arrangement for electrical high-voltage (HV) connections.

Contact arrangements usually have a contact socket and a contact bolt that can be inserted into the contact socket. In vibration-prone environments, such as in vehicles, relative movements can occur between the contact socket and the contact bolt inserted into the contact socket, which wear down the electrical contact over time. This wear leads to a deterioration or interruption of the electrical contact. Particularly when transmitting high currents or voltages, interruptions in the contact can also lead to arcing, which damages the contact arrangement.

There is a need for a contact arrangement that is more wear-resistant.

### BRIEF DESCRIPTION OF THE INVENTION

In one embodiment, a contact arrangement for electrical HV connections is provided including a contact socket and a contact bolt that can be inserted into the contact socket along an insertion direction, with a spring arrangement comprising a spring which, when the contact bolt is inserted into the contact socket, is arranged and compressed between the contact socket and the contact bolt in a radial direction, with a support surface arrangement which has at least one support surface inclined relative to the insertion direction, wherein the compressed spring is supported on the support surface arrangement and an axial spring force pointing in the insertion direction is generated on the support surface arrangement by the compressed spring supported thereon.

The spring arrangement makes it possible to hold the contact socket with the contact bolt inserted into the contact socket in the insertion direction under force. The spring arrangement counteracts forces generated by vibrations that would lead to relative movements between the contact socket and the contact bolt.

The subject matter herein can be further improved by the following features, each of which is advantageous in itself and can be combined with each other as desired.

The support surface arrangement can be part of the contact pin and/or the contact socket or extend over the contact pin and/or the contact socket. In one embodiment, only the contact socket or only the contact bolt may have at least one support surface. Preferably, both the contact socket and the contact bolt have at least one support surface. In a particularly simple design, the contact bolt and the contact socket each have exactly one support surface.

The at least one support surface of the support surface arrangement may be inclined at an acute, obtuse or right angle to the insertion direction.

According to an advantageous embodiment, the contact bolt may have at least one stop surface and the contact socket may have at least one stop surface, wherein the at least one stop surface of the contact bolt and the at least one stop surface of the contact socket are pressed against each other by the axial spring force when the contact bolt is inserted into the contact socket. The stop surfaces simply form a stop that limits the insertion depth of the contact bolt into the contact socket along the insertion direction.

In order to achieve a self-centring effect between the contact socket and the contact bolt, the at least one stop surface of the contact socket and/or the at least one stop surface of the contact bolt may have a normal that extends obliquely to the insertion direction. A particularly good self-centring effect between the contact socket and the contact bolt is achieved when the normal of the stop surface of the contact socket and/or the normal of the stop surface of the contact bolt is inclined at an inclination angle between approximately 10° and approximately 45° to the insertion direction. The term “approximately” can denote a deviation of 5 percentage points.

A large contact surface between the at least one stop surface of the contact socket and the at least one stop surface of the contact bolt is achieved when the at least one stop surface of the contact bolt is inclined at the same inclination angle to the insertion direction as the at least one stop surface of the contact socket.

In order to make the contact arrangement simple to manufacture and at the same time self-centring, the stop surface of the contact bolt and/or the contact socket can be cone-shaped at least in sections. The contact socket and/or the contact bolt can have a cone-shaped section on which the cone-shaped stop surface is arranged or from which the cone-shaped stop surface is formed.

In order to provide defined contact points between the contact bolt and the contact socket, the stop surface of the contact bolt and/or the contact socket may be curved, in particular convexly curved, at least in sections. The contact socket and/or the contact bolt may have a curved, in particular spherical, section on which the at least partially curved stop surface of the contact bolt or the contact socket is arranged or from which the at least partially curved stop surface is formed. The aforementioned embodiments are cost-effective, as good contact between the contact bolt and the contact socket is achieved despite higher manufacturing tolerances.

The normal of the at least one stop surface of the contact socket and/or the at least one stop surface of the contact bolt can, of course, also extend at an angle to the insertion direction if the stop surfaces are designed to be curved at least in sections.

According to a further advantageous design, the spring arrangement may have a further spring which, when the contact bolt is inserted into the contact socket, is arranged and compressed between the contact socket and the contact bolt in the radial direction, wherein a radial spring force pointing perpendicular to the axial spring force is generated by the supported compressed further spring. In this way, the contact bolt is braced in the radial direction with the contact socket, wherein relative movements and thus, in particular, vibrations between the contact bolt and the contact socket in the radial direction are at least reduced. At the same time, the further spring rests securely against both the contact bolt and the contact socket. This allows the contact bolt to be connected to the contact socket in a particularly reliable manner via the further spring.

In a particularly conductive design, the further spring is made of a copper alloy, at least in sections.

In order to adapt the springs flexibly to different tasks or functions, the spring may differ from the further spring in at least one property from the following group of properties: an outer diameter measured perpendicular to the insertion direction, a winding diameter, and an electrical conductivity.

The winding diameter of the spring or the additional spring can be measured along the insertion direction. Preferably, the winding diameters and outer diameters of the spring and the additional spring are measured in an unloaded state. This is particularly the case when the contact bolt provided with the springs is not inserted into the contact socket.

In a further embodiment, the spring may differ from the further spring in terms of at least one of the above-mentioned properties from the group of properties in a wire diameter, either alternatively or cumulatively.

The spring and/or the further spring may be made, at least in sections, of a material whose electrical conductivity is greater than the electrical conductivity of the contact bolt and/or the contact socket. This ensures that the current flow between the contact bolt and the contact socket mainly takes place via the spring or the further spring. This improves the electrical contact between the contact bolt and the contact socket.

According to an advantageous embodiment, the spring can perform the function of a locking spring and the further spring can perform the function of a contact spring. The locking spring can ensure the tension between the contact socket and the contact bolt in the insertion direction and the contact spring can ensure the electrical contact between the contact socket and the contact bolt.

Preferably, the further spring has a higher electrical conductivity than the spring. In this embodiment in particular, but also in embodiments independent thereof, the spring may additionally have a smaller outer diameter and/or a larger winding diameter and/or be made of a mechanically more stable material than the further spring.

The spring is preferably made of stainless steel in order to be able to provide a large axial spring force.

In order to fix the contact bolt in the contact socket, in particular to prevent the contact bolt from slipping out of the contact socket along the insertion direction, the contact socket may have at least one protrusion which is arranged between the spring and the further spring with respect to the insertion direction and protrudes between the spring and the further spring. The at least one protrusion may protrude inwards in the radial direction. A further advantage of this design is that the spring and the further spring are fixed on the contact bolt at least in one axial direction.

The at least one protrusion may, for example, be formed by a bead-shaped thickening or a cylindrical section of the contact socket. The protrusion may extend closed or continuously around the insertion direction. The at least one protrusion may also be designed as a bolt projecting inward in the radial direction or as a rib projecting inward in the radial direction. In these designs, it is preferable to provide several protrusions spaced apart from each other in the circumferential direction, which are preferably arranged equidistantly.

According to a space-saving design of the contact arrangement, the spring and/or the further spring may be annular and extends around the contact bolt. The spring and/

[symbol]

or the further spring may be torus-shaped in particular. Preferably, the spring and/or the further spring extends closed around the contact bolt in order to ensure uniform generation of the spring force along the circumferential direction extending around the insertion direction.

The annular spring may be, for example, a ring spring or a coil spring, as these are space-saving and easy to install. However, other types of springs are also possible, of course.

In order to ensure sufficient force generation, the winding diameter of the spring can correspond to approximately one third of the diameter of the contact bolt measured perpendicular to the insertion direction. The diameter of the contact bolt can be measured at an axial height that corresponds to an axial height of the spring.

In order to securely fasten the spring and/or the further spring to the contact bolt and to protect the spring and/or the further spring from damage, the contact bolt may have at least one groove extending around the insertion direction, in which groove at least one spring of the spring arrangement is received at least in sections. A spring of the spring arrangement refers to both the spring and the further spring.

A groove can be designed to be complementary to the spring accommodated in this groove and can thus be annular, for example.

In order to center the spring or the further spring in the groove, a cross-section of the at least one groove, the cross-section extending along the insertion direction, may be angular. The cross-section may be polygonal, for example triangular, rectangular or pentagonal. Of course, the cross-section of the groove can also be curved, at least in sections, for example round, oval or U-shaped. The cross-section can be measured along a cross-sectional plane extending along the insertion direction.

A particularly well-fixed and protected spring arrangement is achieved according to a further embodiment when each spring of the spring arrangement is received in a groove of the contact bolt. In this embodiment, the spring and the further spring are therefore each arranged in a groove of the contact bolt. Preferably, the spring is arranged in a different groove than the further spring. However, it is of course also conceivable that the spring and the further spring are arranged in the same groove or grooves.

In order to achieve a high degree of functional integration and to make the contact arrangement structurally simple, at least one support surface of the support surface arrangement may be formed at least in sections by the at least one groove. Thus, if the support surface arrangement has only one support surface arranged on the contact bolt, this support surface can be formed by the at least one groove. If the support surface arrangement comprises two or more support surfaces arranged on the contact bolt, at least one of these two or more support surfaces may be formed by the at least one groove. Preferably, each support surface arranged on the contact bolt is formed by the at least one groove.

According to a structurally simple design of the contact arrangement, at least one support surface of the support surface arrangement may be formed at least in sections by an undercut of the contact socket. The undercut preferably extends perpendicular to the insertion direction. Analogous to the above explanations, if the support surface arrangement has only one support surface arranged on the contact socket, this support surface may be arranged on the undercut. If the support surface arrangement comprises two or more support surfaces arranged on the contact socket, at least one of these two or more support surfaces may be formed by the at least one undercut. Preferably, each support surface arranged on the contact socket is arranged at the at least one undercut or formed by it.

The undercut may be arranged at an axial end of the contact socket facing away from the insertion opening of the contact socket. The insertion opening of the contact socket may be understood to be the opening through which the contact bolt can be inserted into the contact socket. In one embodiment, the undercut of the contact socket can be formed by a recess extending perpendicular to the insertion direction or by a recess in the contact socket extending perpendicular to the insertion direction.

In a cost-effective design, the contact socket may have a section that widens in a funnel-shaped manner along the insertion direction, wherein the undercut may be formed at least in sections by the section that widens in a funnel-shaped manner. An inner diameter of the section that widens in a funnel-shaped manner, measured perpendicular to the insertion direction, may become larger in the insertion direction, in particular linearly or progressively larger. In a particularly cost-effective design that is easy to automate, the funnel-shaped widening section may correspond to or have a chamfer.

In an embodiment of the contact arrangement, which is compact at least in the insertion direction, the at least one stop surface of the contact socket and/or the at least one stop surface of the contact bolt may be arranged between the spring and the further spring with respect to the insertion direction. Preferably, the at least one stop surface of the contact socket and/or the contact pin is arranged centrally between the spring and the further spring, for example to prevent the contact pin and the contact socket from tilting.

According to a further advantageous embodiment, the contact bolt may have at least one opening extending in the insertion direction. In this way, the contact bolt can accommodate further elements, for example electronic components such as cables or sensors, or at least one section of a touch guard. The opening also saves material and thus weight. The opening is preferably designed as a through-opening.

The opening can be configured to accommodate at least a section of a touch protection. In one embodiment, the contact arrangement has such a touch protection attached to the opening. The touch protection can also be arranged at least in sections in the opening.

The invention is explained in more detail below with reference to the accompanying figures. Individual features present in the following embodiment may be omitted if, according to the above embodiments, the technical effect associated with this feature is not relevant. Conversely, a feature described above but not present in a subsequent embodiment may be added to the embodiment if the technical effect associated with this feature is important for a particular application.

In the following, the same reference numerals are used for elements that correspond to each other in terms of structure and/or function.

### BRIEF DESCRIPTION OF THE DRAWINGS

FIG. 1 a schematic cross-sectional view of a contact arrangement according to a possible embodiment;

FIG. 2 a schematic cross-sectional view of the contact socket of the contact arrangement from FIG. 1;

FIG. 3 a schematic cross-sectional view of the contact bolt of the contact arrangement from FIG. 1;

FIG. 4 a schematic cross-sectional view of a contact socket according to a further possible embodiment;

FIG. 5 a schematic cross-sectional view of a contact bolt according to another possible embodiment;

FIG. 6 a schematic cross-sectional view of a contact socket according to another possible embodiment;

FIG. 7 a schematic cross-sectional view of a contact arrangement according to a further possible embodiment; and

FIG. 8 a schematic cross-sectional view of a contact bolt provided with the spring and the further spring according to a further possible embodiment.

### DETAILED DESCRIPTION OF THE INVENTION

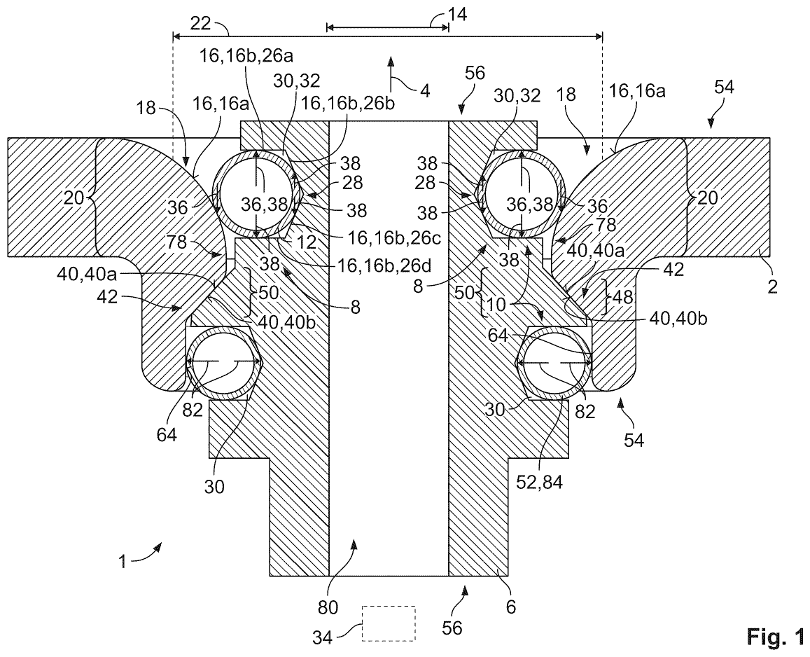

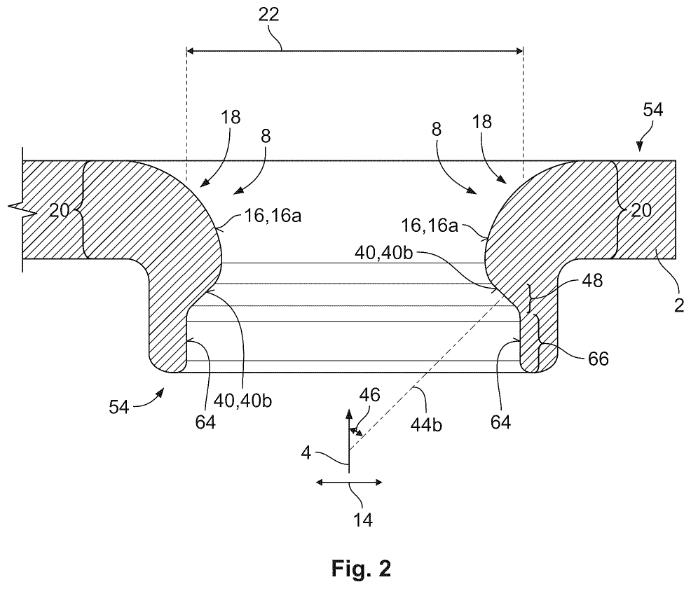

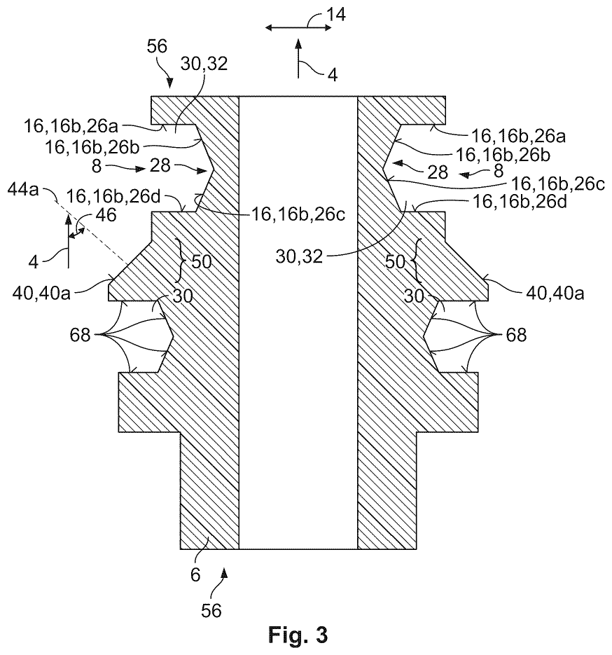

FIG. 1 shows a contact arrangement 1 with a contact socket 2 and a contact bolt 6 inserted into the contact socket 2 along an insertion direction 4. For the sake of clarity, the contact bolt 6 and the contact socket 2 are shown separately from each other in FIGS. 2 and 3, respectively. The contact arrangement 1 further comprises a support surface arrangement 8 and a spring arrangement 10. In the present embodiment, the spring arrangement 10 has a spring 12 which is arranged and compressed in a radial direction 14 between the contact socket 2 and the contact bolt 6. In the present embodiment, the spring 12 is supported-purely exemplary-between a support surface 16, 16a arranged on the contact socket 2 and several support surfaces 16, 16b arranged on the contact bolt 6. The support surfaces 16, 16a, 16b are inclined relative to the insertion direction 4.

Of course, in accordance with other embodiments, only the contact socket 2 or only the contact bolt 6 may have one or more than one support surface 16. Similarly, both the contact socket 2 and the contact bolt 6 may each have at least one support surface 16.

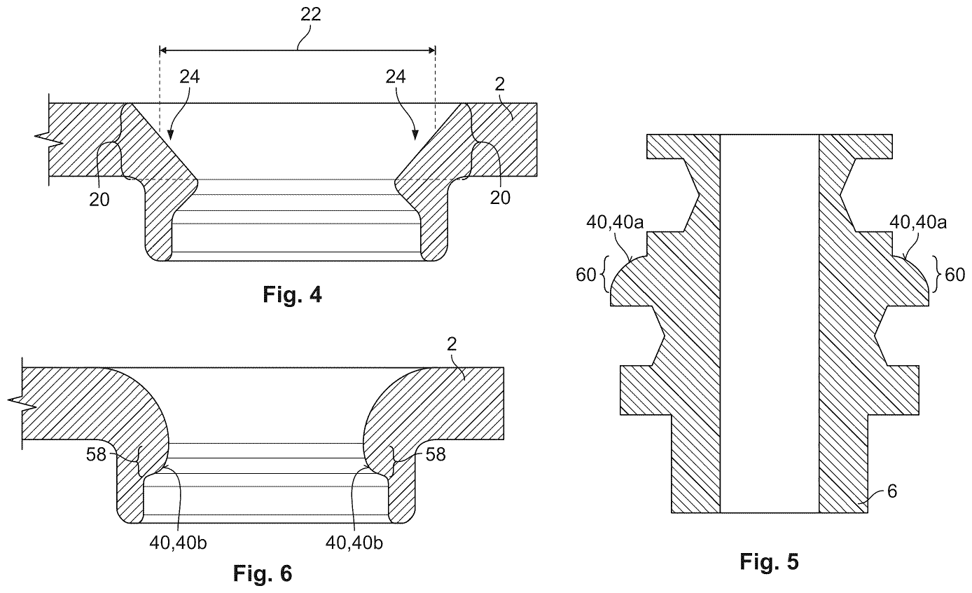

In the present embodiment, the support surface 16a arranged on the contact socket 2 is formed purely by way of example by an undercut 18 of the contact socket 2 or is arranged on the undercut 18 of the contact socket 2. The undercut 18 can be formed by a section 20 that widens in a funnel shape in the insertion direction 4. The funnel-shaped widening can be understood to mean that an inner diameter 22 of the section 20 measured perpendicular to the insertion direction 4 becomes larger in the insertion direction 4. In the present embodiment, the inner diameter 22 of the section 20 increases progressively in the insertion direction 4, so that the funnel-shaped widening section 20 of the contact socket 2 resembles the bell of a trumpet. Of course, the inner diameter 22 of section 20 may also increase linearly in other embodiments. Thus, as can be seen in FIG. 4, the funnel-shaped widening section 20 may correspond to a chamfer 24 in cost-effective embodiments.

The support surfaces 16, 16b of the contact bolt 6 can be formed, for example, by a groove 30 of the contact bolt 6 extending around the insertion direction 4. The contact bolt 6 may in particular have a first support surface 16, 16b, 26a, a second support surface 16, 16b, 26b, a third support surface 16, 16b, 26c and a fourth support surface 16, 16b, 26d. The first and second support surfaces 16, 16b, 26a, 26b may each point in the opposite direction to the insertion direction 4, while the third and fourth support surfaces 16, 16b, 26c, 26d may point in the insertion direction 4. In the design shown in FIGS. 1 to 3, the first support surface 16, 16b, 26a and the fourth support surface 16, 16b, 26d of the contact bolt 6 are opposite each other in relation to the insertion direction 4, purely by way of example, and both extend perpendicular to the insertion direction 4. The second and third support surfaces 16, 16b, 26b, 26c may, for example, be V-shaped, in particular converging at an obtuse angle to form a corner 28 in which the spring 12 is received at least in sections. Such an arrangement of the support surfaces 16 contributes to self-centring of the spring 12 in the groove 30.

However, the groove 30 does not necessarily have to have an angular cross-section 32, but can also be round, for example circular, in particular semicircular, and in particular complementary to an outer contour of the spring 12 accommodated in the groove 30. The cross-section 32 of the groove 30 can be measured in a cross-sectional plane 34 extending along the insertion direction 4.

The compression of spring 12 between contact socket 2 and contact bolt 6 generates an axial spring force 36 pointing in the insertion direction 4 at the support surface arrangement 8 on which spring 12 is supported. The axial spring force 36 is shown schematically in FIG. 1. In the design shown in FIGS. 1 to 3, in which the contact bolt 6 has, for example, several support surfaces 16, 16b, 26a, 26b, 26c, 26d, a portion of the axial spring force 36 exerted on the contact bolt 6 can be transmitted to each of the support surfaces 16, 16b, 26a, 26b, 26c, 26d of the contact bolt 6 can transmit a portion of the axial spring force 36 exerted on the contact bolt 6. These portions of the axial spring force 36 are shown in FIG. 1 as partial axial spring forces 38 for clarification. In the embodiment shown, the contact socket 2 has, purely by way of example, only a single support surface 16, 16a, via which the spring 12 transmits the entire axial spring force 36 to the contact socket 2.

Since the axial spring force 36 transmitted by the spring 12 to the contact socket 2 is opposite to the axial spring force 36 transmitted by the spring 12 to the contact bolt 6, the spring 12 pushes the contact socket 2 and the contact bolt 6 apart along the insertion direction 4. However, in the present embodiment, the axial spring force 36 does not result in relative movement with respect to the insertion direction 4 between the contact socket 2 and the contact bolt 6, since the contact bolt 6 and the contact socket 2 each have a stop surface 40 which are pressed against each other by the axial spring force 36. The stop surfaces 40 can absorb the axial spring forces 36 transmitted between the spring 12 and the support surfaces 26 of the support surface arrangement 8, thereby clamping the contact socket 2 to the contact pin 6 in the insertion direction 4. The stop surfaces 40, 40a of the contact bolt 6 and the stop surface 40, 40b of the contact socket 2 thus form a stop 42 which limits the insertion depth of the contact bolt 6 into the contact socket 2.

The stop surface 40, 40b of the contact socket 2 and the stop surface 40, 40a of the contact bolt 6 each have a normal 44a, 44b, which in the present embodiment extends obliquely to the insertion direction 4 and obliquely to the axial spring force 36, respectively. An inclination angle 46, by which the normal 44a of the stop surface 40, 40b of the contact bolt 6 and/or the normal 44b of the stop surface 40, 40a of the contact socket 2 is inclined relative to the insertion direction 4, can be, for example, between approximately 10° and approximately 45°. In the embodiment shown in FIGS. 1 to 3, both the stop surface 40, 40a of the contact bolt 6 and the stop surface 40, 40b of the contact socket 2 are inclined at an inclination angle 46 of 45°.

In the embodiment shown in FIGS. 1 to 3, the stop surfaces 40, 40a, 40b of the contact bolt 6 and the contact socket 2, respectively, are designed in a conical shape purely by way of example. The cone-shaped stop surfaces 40, 40a, 40b can be formed by a cone-shaped section 48 of the contact socket 2 or by a cone-shaped section 50 of the contact bolt 6, which can be designed to be complementary to each other. Of course, the stop surface 40, 40b of the contact socket 2 and the stop surface 40, 40a of the contact bolt 6 do not necessarily have to be arranged between the spring 12 and a further spring 52 with respect to the insertion direction 4, as shown in the embodiments in FIGS. 1 to 3. In other embodiments, the stop surface 40, 40b of the contact socket and/or the stop surface 40, 40a of the contact bolt 6 may, for example, be arranged at an axial end 54 of the contact socket 2 or an axial end 56 of the contact bolt 6. An embodiment in which the stop surface 40, 40a of the contact bolt 6 is arranged at one of its axial ends 56 is shown, for example, in FIG. 7.

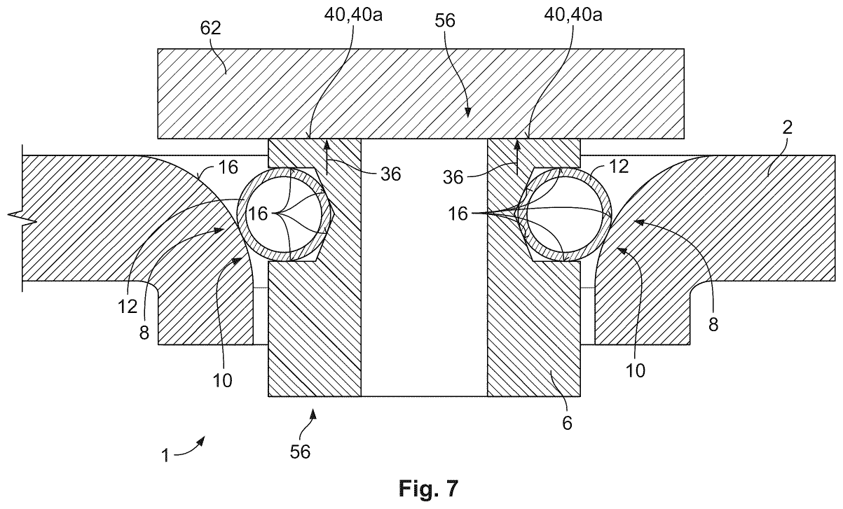

According to other embodiments, the at least one stop surface 40, 40a of the contact bolt 6 and/or the at least one stop surface 40, 40b of the contact socket may be curved, in particular convexly curved, at least in sections. FIGS. 5 and 6 show, purely by way of example, a contact socket 2 and a contact bolt 6, respectively, each with a stop surface 40, 40a, 40b that is convexly curved. The curved stop surfaces 40, 40a, 40b can be formed by or arranged on an arched section 58 of the contact socket 2 or an arched section 60 of the contact bolt 6. If the contact bolt 6 shown in FIG. 5 is additionally provided with the spring 12 and inserted into the contact socket 2 shown in FIG. 6, the convexly curved stop surface 40, 40a of the contact bolt 6 is pressed against the convexly curved stop surface 40, 40b of the contact socket 2 by the axial spring force 36 generated by the spring 12. In this way, a defined contact between the stop surfaces 40, 40a, 40b of the contact bolt 6 and the contact socket 2 is ensured even if the stop surfaces 40, 40a, 40b are manufactured with higher tolerances. Such a design is therefore more cost-effective to manufacture.

As can be seen in FIG. 7, the contact bolt 6 and the contact socket 2 do not necessarily have to each have a stop surface 40, 40a, 40b in order for the contact bolt 6 to be clamped to the contact socket 2 by the spring arrangement 10. FIG. 7 shows in fact a contact arrangement 1 whose contact socket 2 does not have a stop surface 40, 40b. In this design, only the contact bolt 6 is provided with a stop surface 40, 40a, which is arranged at one of its axial ends 56. The spring 12, which, as in the design shown in FIGS. 1 to 3, is supported on the support surfaces 16 of the support surface arrangement 8, presses the contact bolt 6 in this design against an axial stop 62, which, purely by way of example, is not part of the contact socket 2 here. The axial stop 62 may correspond to an element separate from the contact arrangement 1, in the vicinity of which the contact arrangement 1 is mounted. The axial stop 62 absorbs the axial spring force 36 generated by the spring 12, so that the contact bolt 6 is braced in the insertion direction 4.

As can be seen from FIG. 1, the spring arrangement 10 may comprise a further spring 52, which in the embodiment shown is also arranged in sections in a groove 30 extending around the insertion direction 4. When the contact bolt 6 is inserted into the contact socket 2, the further spring 52 is arranged and compressed in the radial direction 14 between the contact socket 2 and the contact bolt 6. The compression of the further spring 52 between the contact socket 2 and the contact bolt 6 generates a radial spring force 82 perpendicular to the axial spring force 36, which is shown here purely schematically. The radial spring force 82 is perpendicular to the insertion direction 4. Due to the radial spring force 82, the further spring 52 is firmly pressed against both the contact socket 2 and the contact bolt 6, so that the contact socket 2 and the contact bolt 6 are also firmly clamped together in the radial direction 14. This improves or secures the electrical contact between the contact socket 2 and the contact bolt 6, especially when the further spring 52 is used as a contact spring 84. Such a further spring 52 designed as a contact spring 84 is preferably made of an electrically conductive material, for example a copper alloy.

On the contact socket side, the further spring 52 can be supported, as shown in FIG. 1, on an inner wall 64 of the contact socket 2, which extends along the insertion direction 4. As can be seen particularly well in FIG. 2, the inner wall 64 can be part of a hollow-cylindrical section 66 of the contact socket 2. On the contact pin side, the further spring 52 can be supported, for example, on inner surfaces 68 of the groove 30, which can be clearly seen in FIG. 3. The arrangement of the inner surfaces 68 can correspond to the arrangement of the first, second, third and fourth support surfaces 26a, 26b, 26c, 26d.

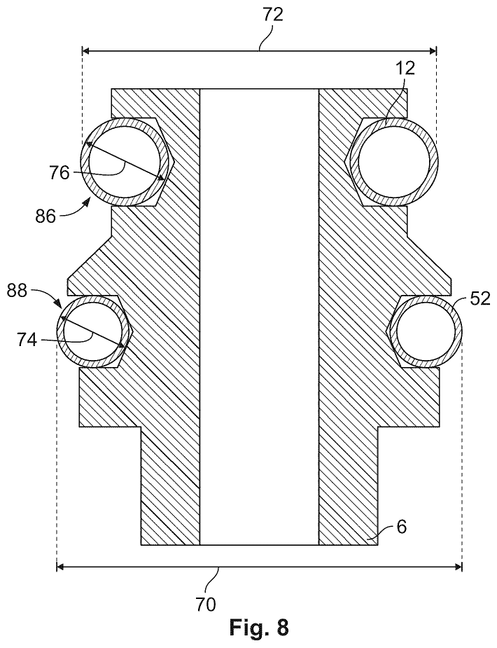

In the embodiment of the contact bolt 6 shown in FIG. 8, an outer diameter 70 of the further spring 52 is larger than an outer diameter 72 of the spring 12. The outer diameters 70, 72 are measured in a direction perpendicular to the insertion direction 4. In the embodiment shown, the spring 12 and the further spring 52 can each have a winding diameter 74, 76 measured along a cross-section 86 of the spring 12 or a cross-section 88 of the further spring 52, respectively. In the present embodiment, the winding diameter 74 of the further spring 52 may be smaller than the winding diameter 76 of the spring 12. Of course, the winding diameters 74, 76 and/or outer diameters 70, 72 of the two springs 12, 52 may also be identical in other embodiments or have a different size ratio than that described above.

As can also be seen from FIG. 1, the contact socket 2 may have at least one protrusion 78 which is arranged between the spring 12 and the further spring 52 in the insertion direction 4 and protrudes between the spring 12 and the further spring 52. In the present embodiment, the cone-shaped section 48 of the contact socket 2, from which the stop surface 40, 40b of the contact socket 2 may be formed, may be part of this protrusion 78. Of course, the protrusion 78 may also be designed differently, for example as a bead-shaped thickening or as a cylindrical section of the contact socket 2. Likewise, the protrusion 78 does not have to be closed or extend continuously around the insertion direction 4. For example, a plurality of (individual) protrusions 78 may be provided which protrude inwards in the radial direction 14.

As can also be seen in FIGS. 1 and 3, the contact bolt 6 may have at least one opening 80 extending in the insertion direction 4. The opening 80 is preferably designed as a through-opening extending between the axial ends 56 of the contact bolt 6. The opening 80 of the contact bolt 6 may, for example, be designed to accommodate touch protection at least in sections. At least one section of the touch protection may protrude into the opening 80 of the contact bolt 6 at one of the axial ends 56. The touch protection can prevent human fingers or test fingers, for example VDE test fingers, from being inserted into the opening 80. The opening 80 also has the advantage of saving material and thus weight.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Contact arrangement for electrical high-voltage (HV) connections comprising:
a contact socket and a contact bolt that can be inserted into the contact socket along an insertion direction,
a spring arrangement comprising a spring which, when the contact bolt is inserted into the contact socket, is arranged and compressed between the contact socket and the contact bolt in a radial direction,
a support surface arrangement which has at least one support surface inclined relative to the insertion direction,
wherein the compressed spring is supported on the support surface arrangement and an axial spring force pointing in the insertion direction is generated on the support surface arrangement by the compressed spring supported thereon.

2. Contact arrangement according to claim 1,
wherein the contact bolt has at least one stop surface and the contact socket has at least one stop surface, and wherein the at least one stop surface of the contact bolt and the at least one stop surface of the contact socket are pressed against each other by the axial spring force when the contact bolt is inserted into the contact socket.

3. Contact arrangement according to claim 2,
wherein the at least one stop surface of the contact socket and/or the at least one stop surface of the contact bolt has a normal that extends obliquely to the insertion direction.

4. Contact arrangement according to claim 1,
wherein the spring arrangement has a further spring which, when the contact bolt is inserted into the contact socket, is arranged and compressed between the contact socket and the contact bolt in the radial direction,
and wherein a radial spring force pointing perpendicular to the axial spring force is generated by the supported compressed further spring.

5. Contact arrangement according to claim 4,
wherein the spring differs from the further spring in at least one property from the following group of properties:
an outer diameter measured perpendicular to the insertion direction,
a winding diameter, and
an electrical conductivity.

6. Contact arrangement according to claim 4,
wherein the contact socket has at least one protrusion which is arranged between the spring and the further spring with respect to the insertion direction and protrudes between the spring and the further spring.

7. Contact arrangement according to claim 1,
wherein the spring and/or the further spring is annular and extends around the contact bolt.

8. Contact arrangement according to claim 1,
wherein the contact bolt has at least one groove extending around the insertion direction, in which groove at least one spring of the spring arrangement is received at least in sections.

9. Contact arrangement according to claim 8,
wherein a cross-section of the at least one groove, the cross-section extending along the insertion direction, is angular.

10. Contact arrangement according to claim 8,
wherein each spring of the spring arrangement is received in a groove of the contact bolt.

11. Contact arrangement according to claim 8,
wherein at least one support surface of the support surface arrangement is formed at least in sections by the at least one groove.

12. Contact arrangement according to claim 1,
wherein at least one support surface of the support surface arrangement is formed at least in sections by an undercut of the contact socket.

13. Contact arrangement according to claim 12,
wherein the spring arrangement has a further spring which, when the contact bolt is inserted into the contact socket, is arranged and compressed between the contact socket and the contact bolt in the radial direction,
wherein a radial spring force pointing perpendicular to the axial spring force is generated by the supported compressed further spring, and
wherein the contact socket has a section that widens in a funnel-shaped manner along the insertion direction, and wherein the undercut is formed at least in sections by the section that widens in a funnel-shaped manner.

14. Contact arrangement according to claim 1,
wherein the at least one stop surface of the contact socket and/or the at least one stop surface of the contact bolt is arranged between the spring and the further spring with respect to the insertion direction.

15. Contact arrangement according to claim 1,
wherein the contact bolt has at least one opening extending in the insertion direction.
